(19) United States
(12) Patent Application Publication
(10) Pub. No.: US 2024/0196817 A1
(43) Pub. Date: Jun. 20, 2024

(54) Wind-Resistant Irrigation System

(71) Applicant: William George Bolton, Longmont, CO (US)

(72) Inventor: William George Bolton, Longmont, CO (US)

(21) Appl. No.: 18/066,599

(22) Filed: Dec. 15, 2022

(51) Int. Cl. A01G 25/09; A01G 25/16

(52) U.S. Cl. CPC A01G 25/092; A01G 25/167

(57) ABSTRACT

An irrigation tower is provided. The irrigation tower includes one or more of a pair of vertical members, a first end of each coupled to a water pipe and configured to pivot in relation to the water pipe, a horizontal member, each end coupled to a second end of each of the pair of vertical members and configured to pivot in relation to the second ends, and a plurality of wheels, each coupled to the horizontal member. A distance between ends of one of the horizontal member or the pair of vertical members is configured to change to lower or raise the water pipe with respect to the horizontal member.

### FIELD

The present invention is directed to irrigation towers. In particular, the present invention is directed to apparatuses and systems for providing wind-resistant irrigation towers for commercial irrigation systems.

### BACKGROUND

Center pivot irrigation is a form of sprinkler irrigation utilizing several segments of pipe (usually galvanized steel or aluminum) joined and supported by trusses, mounted on wheeled towers with sprinklers positioned along its length. The system moves in a circular pattern and is fed with water from the pivot point at the center of an arc. These systems are found and used in all parts of the world and allow irrigation of almost all types of terrain. Newer systems have drop sprinkler heads.

As of 2017, most center pivot systems have drops hanging from a pipe with sprinkler heads that are positioned a few feet (at most) above crops, thus limiting evaporative losses. Drops can also be used with drag hoses or bubblers that deposit the water directly on the ground between crops. Crops are often planted in a circle to conform to the center pivot. Originally, most center pivots were water-powered. These were replaced by hydraulic systems and electric-motor-driven systems. Many modern pivots feature GPS devices to help maintain arm alignment by speeding up or slowing specific irrigation towers. Some irrigation systems utilize a rotating corner swing mounted to the last tower of an irrigation arm in order to apply water to corners of square fields.

A series of pipe sections, each with one or more wheels affixed to a tower between pipe sections, and sprinklers along its length, are coupled together. Water is supplied at the center pivot. The wheels are perpendicularly mounted to the towers with respect to the pipe sections to facilitate circular movement of the irrigation system about the central pivot swivel seal housed in a fixed derrick.

### SUMMARY

The present invention is directed to solving disadvantages of the prior art. In accordance with embodiments of the present invention, an irrigation tower is provided. The irrigation tower includes one or more of a pair of vertical members, a first end of each coupled to a water pipe and configured to pivot in relation to the water pipe, a horizontal member, each end coupled to a second end of each of the pair of vertical members and configured to pivot in relation to the second ends, and a plurality of wheels, each coupled to the horizontal member. A distance between ends of one of the horizontal member or the pair of vertical members is configured to change to lower or raise the water pipe with respect to the horizontal member.

In accordance with another embodiment of the present invention, an irrigation system is provided. The irrigation system includes one or more of a fixed derrick, an irrigation arm, a wind speed sensor configured to provide a current wind speed, and a controller. The fixed derrick includes a water source and a water pump, coupled to the water source. The irrigation arm includes a water pipe, coupled to the water pump and extending radially away from the fixed derrick, one or more sprinkler heads, coupled to the water pipe, and one or more irrigation towers, coupled to and transversely supporting the water pipe, Each irrigation tower includes a pair of vertical members, a first end of each coupled to the water pipe and configured to pivot in relation to the water pipe, a horizontal member, each end coupled to a second end of each of the pair of vertical members and configured to pivot in relation to the second ends, a plurality of wheels, each coupled to the horizontal member, and a plurality of actuators, configured to raise or lower an associated irrigation tower. The controller is coupled to the wind speed sensor and is configured to monitor the current wind speed, determine the current wind speed is above a first threshold and in response lower the irrigation towers, and determine the current wind speed is below a second threshold that is below the first threshold and in response raise the irrigation towers.

An advantage of the present invention is that it provides a self-regulating automated irrigation system capable of resisting high winds by reducing the frontal area of the arm by lowering itself and following the high wind event, raising itself and continuing its irrigation. A controller continuously monitors current wind speed in the area of the irrigation system and configures the system for high winds if high winds are detected.

Another advantage of the present invention is it provides wind-resistant irrigation towers. Wind-resistant irrigation towers change configuration and a height profile in order to reduce the chance of irrigation arm blow-over and resultant damage to the irrigation system and crops or plants.

Another advantage of the present invention is it provides multiple methods for lowering a center of gravity for irrigation towers. Various structural members of irrigation towers may be lengthened or shortened to raise or lower the irrigation tower profile.

Another advantage of the present invention is that it utilizes, in some embodiments, the same actuators used to propel the irrigation arm about an irrigated area to change a height profile of the irrigation towers when high winds are detected.

Additional features and advantages of embodiments of the present invention will become more readily apparent from the following description, particularly when taken together with the accompanying drawings.

### BRIEF DESCRIPTION OF THE DRAWINGS

FIG. 1 is a diagram illustrating a top view of an irrigation system in accordance with embodiments of the present invention.

FIG. 2A is a diagram illustrating an isometric view of a conventional art irrigation arm.

FIG. 2B is a diagram illustrating a side view of a conventional art irrigation tower.

FIG. 3A is a diagram illustrating an isometric view of a wind-resistant irrigation arm in accordance with embodiments of the present invention.

FIG. 3B is a diagram illustrating a side view of a wind-resistant tower in accordance with embodiments of the present invention.

FIG. 4A is a diagram illustrating a water pipe in a raised position in accordance with embodiments of the present invention.

FIG. 4B is a diagram illustrating a water pipe in a lowered position in accordance with embodiments of the present invention.

FIG. 5A is a diagram illustrating a front view of an irrigation tower in a raised position in accordance with embodiments of the present invention.

FIG. 5B is a diagram illustrating a front view of an irrigation tower in a lowered position in accordance with embodiments of the present invention.

FIG. 6A is an illustration depicting an isometric view of an irrigation tower in a raised position in accordance with embodiments of the present invention.

FIG. 6B is an illustration depicting an isometric view of an irrigation tower in a lowered position in accordance with embodiments of the present invention.

FIG. 7A is a diagram illustrating a side view of an irrigation tower lowering operation in accordance with embodiments of the present invention.

FIG. 7B is a diagram illustrating a side view of irrigation tower improved stability in the lowered position in accordance with embodiments of the present invention.

FIG. 8A is a diagram illustrating a raised horizontal member in accordance with a first embodiment of the present invention.

FIG. 8B is a diagram illustrating a lowered horizontal member in accordance with a first embodiment of the present invention.

FIG. 9A is a diagram illustrating a raised horizontal member in accordance with a second embodiment of the present invention.

FIG. 9B is a diagram illustrating a lowered horizontal member in accordance with a second embodiment of the present invention.

FIG. 10A is a diagram illustrating a raised vertical member in accordance with a third embodiment of the present invention.

FIG. 10B is a diagram illustrating a lowered vertical member in accordance with a third embodiment of the present invention.

FIG. 11A is a diagram illustrating a raised vertical member in accordance with a fourth embodiment of the present invention.

FIG. 11B is a diagram illustrating a lowered vertical member in accordance with a fourth embodiment of the present invention.

FIG. 12 is a diagram illustrating a raised vertical member in accordance with a fifth embodiment of the present invention.

FIG. 13A is a diagram illustrating a raised vertical member in accordance with a fifth embodiment of the present invention.

FIG. 13B is a diagram illustrating a lowered vertical member in accordance with a fifth embodiment of the present invention.

FIG. 14A is a diagram illustrating vertical member actuation in accordance with a fifth embodiment of the present invention.

FIG. 14B is a diagram illustrating vertical member actuation in accordance with a fifth embodiment of the present invention.

FIG. 15 is a flowchart illustrating an irrigation tower lowering process in accordance with embodiments of the present invention.

FIG. 16 is a flowchart illustrating an irrigation tower raising process in accordance with embodiments of the present invention.

FIG. 17 is a flowchart illustrating a maximum wind speed mitigation process in accordance with embodiments of the present invention.

### DETAILED DESCRIPTION

Irrigation systems provide an efficient way to provide water to large crop fields. With water costs high and increasing, center-pivot irrigation systems provide water directly above crops while minimizing water evaporation across large irrigated areas. Because these systems distribute water radially from a center pivot, the water pipe is movable and positioned above a number of suspended sprinkler downpipes and sprinkler heads. This focuses most of the weight in the water pipe and carried water, which has a high center of gravity across the entire irrigation arm.

High winds may occur often in farmed areas. The winds may be constant, shifting, or gusty, depending on local wind conditions each day. Because large expanses are needed for farming crops, in many cases there may be no trees close by that may serve as windbreaks. In some cases, the winds may bear against the water pipe, carried by conventional towers, due to the physical height of the irrigation towers present in conventional irrigation systems. In some cases, the winds and wind gusts may cause towers and the water pipe to roll over due to the high center of gravity combined with high wind pressure. This prevents operation of the irrigation system until the towers and water pipe are lifted and restored to operating positions and may damage irrigation system components. Additionally, it may require specialized equipment such as a crane to lift the turned-over irrigation arm sections. Damaged towers and water pipes may need to be straightened or replaced. The costs of repairing and restoring irrigation systems may be high in high-wind environments. Therefore, what is needed is a wind-resistant irrigation system that can mitigate blow-over and resultant damage to irrigation system components.

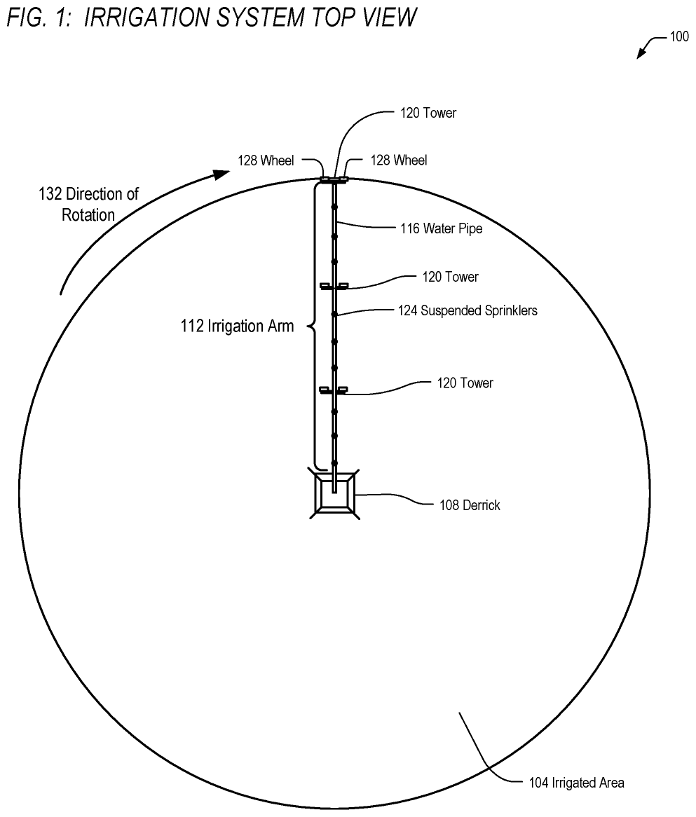

Referring now to FIG. 1, a diagram illustrating a top view of an irrigation system 100 in accordance with embodiments of the present invention is shown. The irrigation system 100 provides water to crops or other plant forms within an irrigated area 104. A fixed derrick 108 is positioned at the center of the irrigated area 104, and provides a supporting structure for a water pipe 116. The derrick 108 may include a pivot that allows the water pipe 116 to rotate 360 degrees. At the derrick 108, the water pipe 116 may be coupled to a water source that supplies water at a designated pressure to the water pipe 116.

An irrigation arm 112 extends from the derrick 108 to the outside edge of the irrigated area 104. The irrigation arm 112 may include the water pipe 116 and one or more irrigation towers 120 that support the water pipe 116 and provide motive force to rotate the irrigation arm 112 about the irrigated area 104. In one embodiment, the water pipe 116 may be divided up into a number of sections between pairs of irrigation towers 120 or a center-most irrigation tower 120 and the derrick 108. In one embodiment, the sections may be of approximately equal length. Each section of the water pipe 116 may include a number of equally-spaced suspended sprinklers 124. The suspended sprinklers 124 may include sprinkler heads that regulate the volume and pattern of water distributed to the irrigated area 104.

Each tower 120 may include one or more wheels 128 that rotate perpendicularly to the irrigation arm 112 to move the irrigation arm 112 in a circular fashion in a direction of rotation 132. In one embodiment, the direction of rotation 132 may be clockwise when viewed from above. In another embodiment, the direction of rotation 128 may be counter-clockwise when viewed from above. Typically, each tower 120 may include two wheels 128, where both wheels 128 may be simultaneously driven in the same direction 132 to move the tower 120.

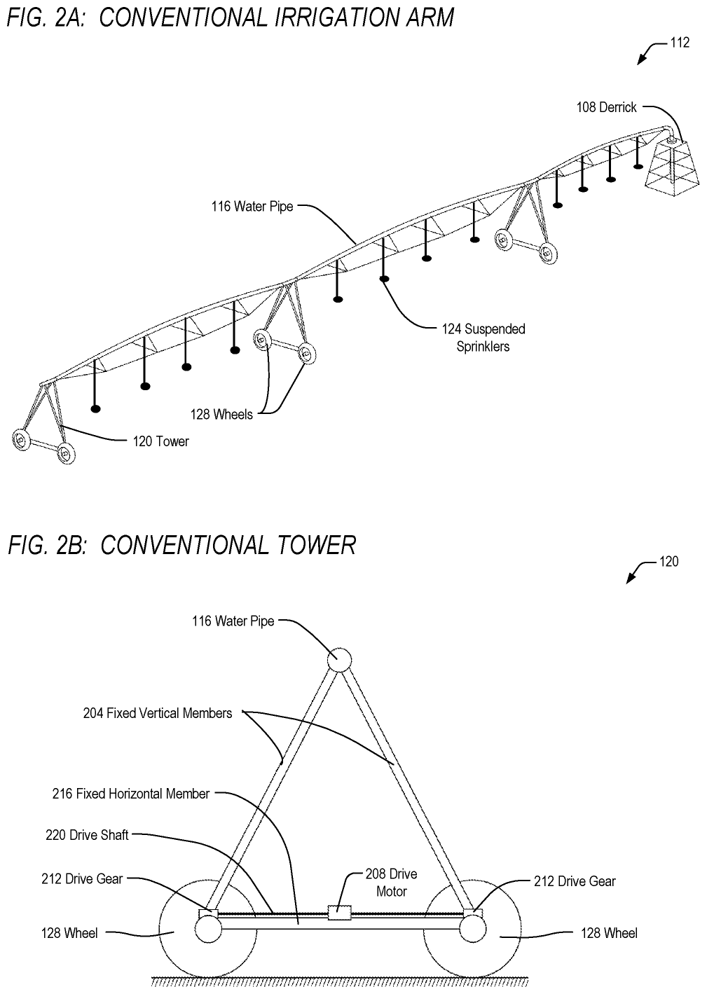

Referring now to FIG. 2A, a diagram illustrating an isometric view of a conventional art irrigation arm 112 is shown. FIG. 2A illustrates a typical irrigation arm 112 of the conventional art, in conformance with the system 100 illustrated in FIG. 1. The water pipe 116 extends from a center pivot of the derrick 108 to an outermost tower 120. Between the derrick 108 and the outermost tower 120 are a number of water pipe 116 sections, with a tower 120 located at a junction point between adjacent sections. Each tower 120 is shown with a pair of wheels 128, and supports the water pipe 116 at the top of a triangular structure.

A number of suspended sprinklers 124 hang from each section of the water pipe 116. In one embodiment, each suspended sprinkler 124 is attached to the water pipe 116 through a hose section. The hose sections may be of unequal length, depending of any “arch” in the water pipe 116, with the goal that all sprinkler heads are a same height above the irrigated area 104 to facilitate even water distribution.

Referring now to FIG. 2B, a diagram illustrating a side view of a conventional art irrigation tower 120 is shown. FIG. 2B illustrates primary components of a conventional irrigation tower 120.

In one embodiment, the structure of an irrigation tower 120 may include a pair of fixed vertical members 204 and a fixed horizontal member 216. Being fixed members, the conventional tower 120 may be substantially rigid and able to support significant weight. The fixed vertical members 204 are joined at a top end of each vertical member 204 by the water pipe 116. In one embodiment, the fixed vertical members 204 are joined at a top end of each vertical member 204 by a sleeve that the water pipe 116 passes through. The fixed vertical members 204 may typically be manufactured from aluminum or steel tubing, and may be brazed or welded to the sides of the sleeve or the water pipe 116.

In one embodiment, a lower end of each of the fixed vertical members 204 is coupled to a fixed horizontal member 216. The fixed horizontal member 216 may typically be manufactured from aluminum or steel tubing, and may be brazed or welded to the lower ends of the fixed vertical members 204. Located near the junction of each vertical member 204 and the horizontal member 216 is a wheel 128 that is coupled to a drive gear 212. In one embodiment, each wheel 128 has an associated drive gear 212 and drive shaft 220. The drive gear 212 translates rotation of a drive shaft 220 into rotation of the wheels 128. When the drive gear 212 rotates in a first direction, the wheel 128 rotates to the left. When the drive gear 212 rotates in a second direction opposite the first direction, the wheel 128 rotates to the right. The conventional tower 120 is configured such that all wheels 128 of the same tower 120 always rotate in a same direction.

The conventional tower 120 may include a drive motor 208. The drive motor, when energized by a power source of a first polarity, is configured to rotate the drive shaft 220 in a first direction to rotate the wheels 128 in a first direction. When energized by a power source of a second polarity opposite the first polarity, is configured to rotate the drive shaft 220 in a second direction opposite the first direction to rotate the wheels 128 in a second direction. In one embodiment, the drive motor 208 receives power from a central power source in proximity to the derrick 108. In one embodiment, when the drive motor 208 does not receive power from the power source, the wheels 128 are locked and cannot rotate either direction.

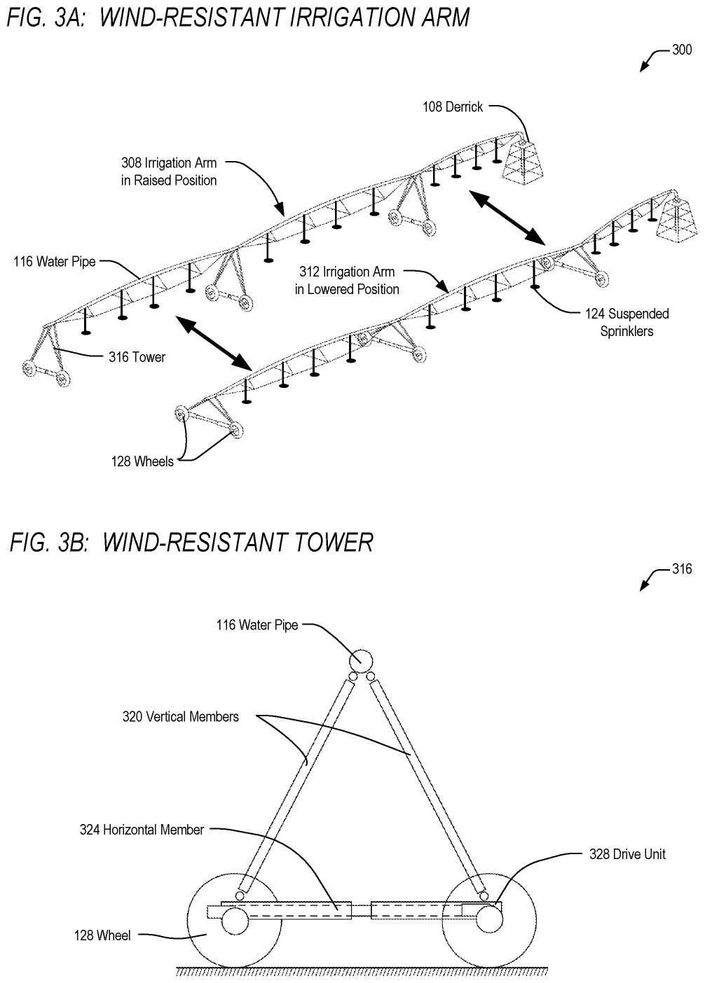

Referring now to FIG. 3A, a diagram illustrating an isometric view of a wind-resistant irrigation arm 300 in accordance with embodiments of the present invention is shown. FIG. 3A illustrates a typical wind-resistant irrigation arm 300 of the present application, in conformance with the system 100 illustrated in FIG. 1. The water pipe 116 extends from a center pivot of the derrick 108 to an outermost tower 316. Between the derrick 108 and the outermost tower 316 are a number of water pipe 116 sections, with a tower 316 located at a junction point between adjacent sections. Each tower 316 is shown with a pair of wheels 128, and supports the water pipe 116 at the top of a triangular structure.

A number of suspended sprinklers 124 hang from each section of the water pipe 116. In one embodiment, each suspended sprinkler 124 is attached to the water pipe 116 through a hose section. The hose sections may be of unequal length, depending of any “arch” in the water pipe 116, with the goal that all sprinkler heads are a same height above the irrigated area 104 to facilitate even water distribution.

In the preferred embodiment, the irrigation arm 300 may be configured as an irrigation arm in a raised position 308 that transitions into an irrigation arm in a lowered position 312, and back again. A controller (not shown) may control whether the irrigation arm is in the raised position 308 or the lowered position 312, according to criteria described herein. A central controller may control the operation of all towers 316 of the wind-resistant irrigation arm 300.

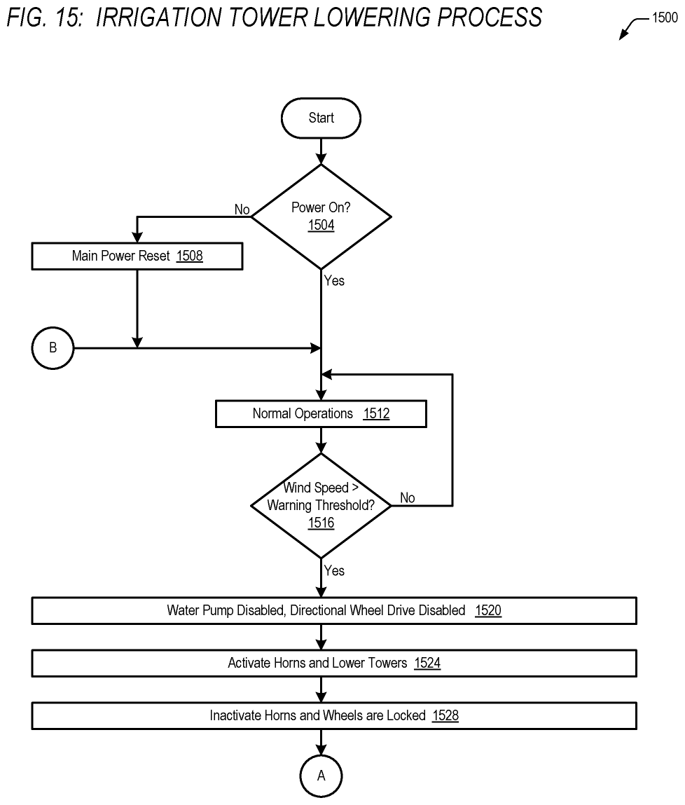

In one embodiment, the controller may include a processor, microcontroller, or field-programmable gate array (FPGA) coupled to one or more memory devices to execute stored programs in the memory devices. This is described in more detail in the flowcharts of FIGS. 15-17.

In one embodiment, the controller may control power distribution through the irrigation arm 300 to a number of actuators in each of the irrigation towers 316. Actuators may include AC or DC motors, solenoids, hydrostatic actuators, or any other form of electromechanical device that converts a received voltage and/or signal into a form of mechanical movement or rotation. A power source (not shown) may supply AC or DC power to a power distributor that selectively provides a voltage to a given actuator (e.g., a drive unit, a vertical member actuator, a horizontal member actuator, etc.) in a given irrigation tower 316 selected by the controller. In this embodiment, it would be expected that the irrigation arm 300 includes a number of electrical connections equal to the total number of actuators in the system 100. The power distribution may provide a positive voltage to a given actuator to cause motion or rotation in a first direction and may provide a negative voltage to the given actuator to cause motion or rotation in a second direction opposite the first direction. In one embodiment, the controller may modulate a magnitude of the positive and/or the negative voltage to control a movement or rotation speed of a corresponding actuator.

In another embodiment, the controller may control the power source to provide an AC or DC voltage through an electrical connection to each actuator in the system 100. In this embodiment, each actuator would include a wireless receiver, a processor, and the appropriate actuator (e.g., a drive unit, a vertical member actuator, a horizontal member actuator, etc.). The controller would wirelessly transmit an addressed command to a specific actuator to move or rotate in a specific direction. Each actuator would have a unique address, and the commands would include the unique address and the command itself (i.e., rotate to the right, rotate to the left, stop, etc.). This embodiment has the advantage of simpler wired connections and greater robustness between the controller and each of the irrigation towers 316 and actuators at the expense of distributed processing components and more expense associated with each actuator.

A possible improvement to the previous embodiment may include one or more energy capture and storage devices at each irrigation tower 316. Either solar panels or a wind energy capture device may provide captured energy (DC voltage) to an energy storage device (e.g., battery etc) at each irrigation tower 316, which provides DC power to the actuators on the irrigation tower 316. This may replace the voltage distribution function associated with the controller such that no wired electrical connections are required in the sections of the irrigation arm 300 between the irrigation towers 316 or between an irrigation tower 300 and the derrick 108.

Referring now to FIG. 3B, a diagram illustrating a side view of a wind-resistant tower 316 in accordance with embodiments of the present invention is shown. FIG. 3B illustrates the primary components of a wind-resistant irrigation tower 316 of a first embodiment, as described herein.

In the illustrated embodiment, the structure of an irrigation tower 316 may include a pair of vertical members 320 and a variable-length horizontal member 324. The vertical members 320 are joined at a top end of each vertical member 320 by the water pipe 116. In one embodiment, the vertical members 320 are joined at a top end of each vertical member 320 by dedicated sleeves that the water pipe 116 passes through. Each vertical member 320 must be coupled to a different sleeve in order to allow each sleeve to rotate in a different direction as the water pipe 116 is raised or lowered with respect to the ground surface. In another embodiment, the vertical members 320 are joined at a top end of each vertical member 320 by a hinge that is attached to a side surface of the water pipe 116. In all instantiations of this embodiment, the vertical members 320 must pivot with respect to the water pipe 116 in order to allow the water pipe 116 to be lowered or raised with respect to a ground surface. The vertical members 320 may typically be manufactured from aluminum or steel tubing.

In one embodiment, a lower end of each of the vertical members 320 is coupled to an end of a variable-length horizontal member 324. The horizontal member 324 may typically be manufactured from aluminum or steel tubing, and may be brazed or welded to a hinge at the lower ends of the vertical members 320. The hinges allow the vertical members 320 to pivot with respect to the horizontal member 324. Located near the junction of each vertical member 320 and the horizontal member 324 is a wheel 128 that is coupled to a drive unit 328. In one embodiment, the drive unit 328 may include a wheel actuator coupled to a drive gear. The drive gear translates motion of a wheel actuator into rotation of a wheel 128. When the drive gear rotates in a first direction, the wheel 128 rotates to the left. When the drive gear rotates in a second direction opposite the first direction, the wheel 128 rotates to the right. Unlike the conventional tower 120, depending on the embodiment the wind-resistant tower 316 may be configured such that all wheels 128 of the same tower 316 rotate independently. For example, in a same direction to the left, in a same direction to the right, in opposite directions to rotate the wheels 128 apart (i.e., thus lengthening the horizontal member 324), or in opposite directions to rotate the wheels 128 together (i.e., thus shortening the horizontal member 324).

The wind-resistant tower 316 may include a separate drive unit 328 for each wheel 128. Each drive unit 328, when energized by a power source of a first polarity, is configured to rotate the wheel 128 in a first direction. When energized by a power source of a second polarity opposite the first polarity, it is configured to rotate the wheel 128 in a second direction opposite the first direction. In one embodiment, the drive units 328 receive power from a central power source in proximity to the derrick 108. In one embodiment, when the drive units 328 do not receive power from the power source, the wheels 128 are locked and cannot rotate in either direction.

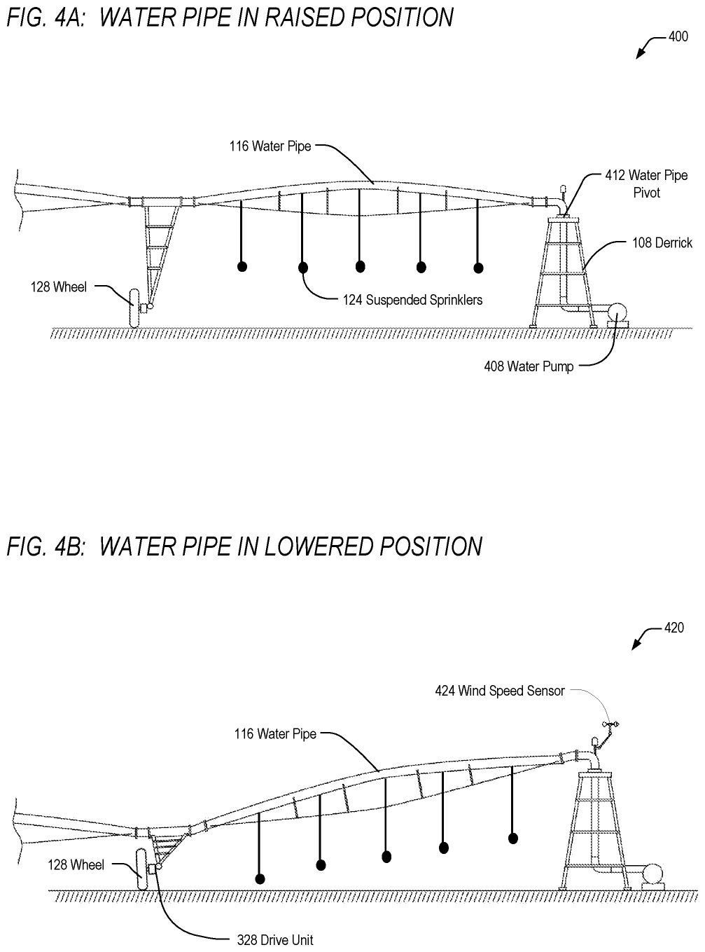

Referring now to FIG. 4A, a diagram illustrating a water pipe in a raised position 400 in accordance with embodiments of the present invention is shown. FIG. 4A illustrates a section of a wind-resistant irrigation arm 316 in a raised position. The wind-resistant irrigation arm 316 is in the raised position while watering crops or other plants in the irrigated area 104.

The derrick 108 is coupled to the water pipe 116 through a water pipe pivot 412. The water pipe pivot 412 allows the water pipe 116 to rotate through 360 degrees. A water pump 408 provides water at a predetermined pressure through the water pipe 116, from a water source. When in the raised position, the wind-resistant irrigation arm 316 maintains a consistent height above the crops or other plants for the suspended sprinklers 124.

Referring now to FIG. 4B, a diagram illustrating a water pipe in a lowered position 420 in accordance with embodiments of the present invention is shown. FIG. 4B illustrates a section of a wind-resistant irrigation arm 316 in a lowered position. The wind-resistant irrigation arm 316 is in the lowered position while high winds are occurring or have recently occurred in the area, as described herein.

In one embodiment, a wind speed sensor 424 may be coupled to the derrick 108. The wind speed sensor 424 provides current wind speed data to a controller (not shown). The controller controls various actuators, including drive units 328, to control irrigation arm 300 and tower 316 movement, as described herein. When in the lowered position, the tower 316 may have a significantly lower center of gravity than in the raised position and much greater resistance to tipping over.

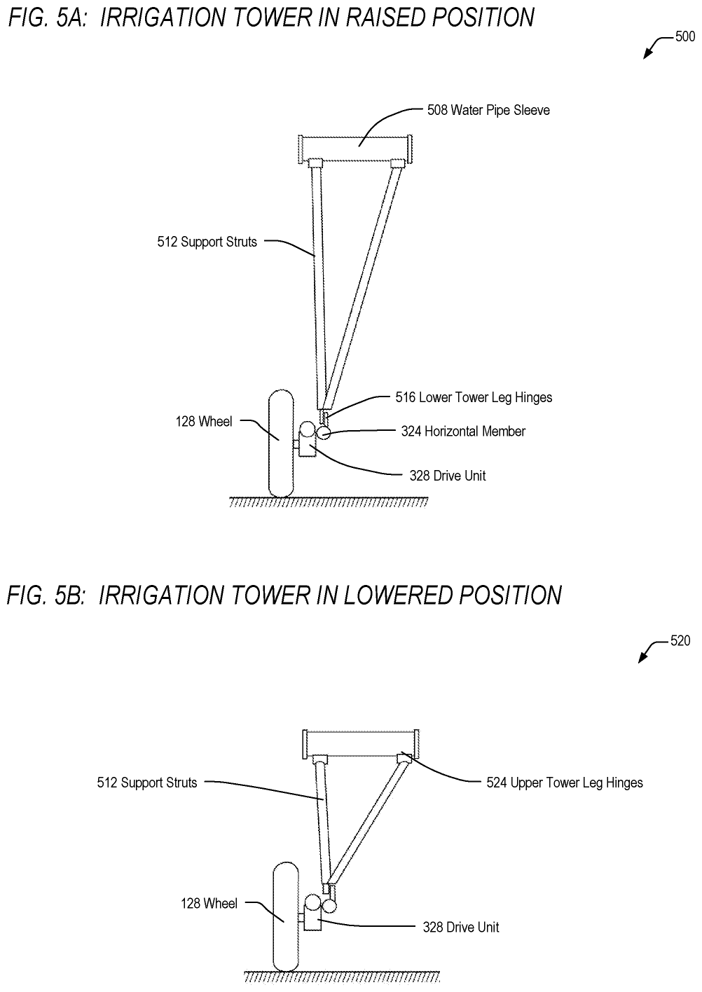

Referring now to FIG. 5A, a diagram illustrating a front view of an irrigation tower in a raised position 500 in accordance with embodiments of the present invention is shown. FIG. 5A represents a perspective just in front of or just behind a wind-resistant tower 316.

In one embodiment, the irrigation tower 316 may include a number of support struts 512 between the horizontal member 324 and the water pipe 116. FIG. 5A illustrates two support struts 512. The support struts 512 may be part of a vertical member 320, as shown in FIG. 3. In one embodiment, a number of horizontal cross-members (not shown) may be welded or brazed between the support struts, lending additional rigidity to the support struts 512. In one embodiment, there may be two lower tower leg hinges 516, one at each intersection of a vertical member 320 and a horizontal member 324. The lower tower leg hinges 516 allow the support struts 512 to pivot with respect to the horizontal member 324.

Referring now to FIG. 5B, a diagram illustrating a front view of an irrigation tower in a lowered position 520 in accordance with embodiments of the present invention is shown. FIG. 5B illustrates the tower 316 in a lowered position with respect to the ground. Each of the support struts 512 is attached to an upper tower leg hinge 524, with two upper tower leg hinges 524 required for the two illustrated support members 512. The upper tower leg hinges 524 allow the support struts 512 to pivot with respect to the water pipe 116 or a water point sleeve 508 that the water pipe 116 passes through.

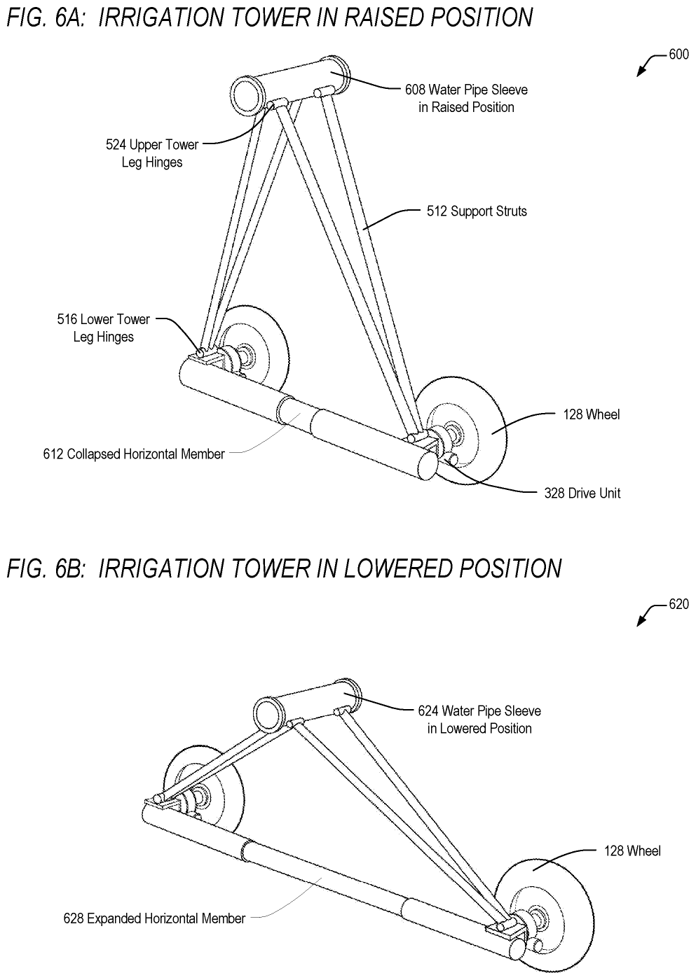

Referring now to FIG. 6A, an illustration depicting an isometric view of an irrigation tower in a raised position 600 in accordance with embodiments of the present invention is shown. FIG. 6A is analogous to FIG. 5A, but provides more context with respect to the horizontal member 324. Visible in FIG. 6A is the water pipe sleeve in a raised position 608, pairs of support struts 512, upper tower leg hinges 524, lower tower leg hinges 516, a pair of wheels 128, and a pair of drive units 328 (one per wheel 128). Because the water pipe 116 or water pipe sleeve is in a raised position, the horizontal member is collapsed 612.

Referring now to FIG. 6B, an illustration depicting an isometric view of an irrigation tower in a lowered position 620 in accordance with embodiments of the present invention is shown. FIG. 6B is analogous to FIG. 5B, but again provides more context with respect to the horizontal member 324. Visible in FIG. 6B is the water pipe sleeve in a lowered position 624, pairs of support struts 512, upper tower leg hinges 524, lower tower leg hinges 516, a pair of wheels 128, and a pair of drive units 328 (one per wheel 128). Because the water pipe 116 or water pipe sleeve is in a lowered position, the horizontal member is expanded 628. In one embodiment, the horizontal member 324 may be configured to freely slide according to the wheels 128 and drive units 328 (i.e., the controller, controlling the wheel actuators, may move the wheels 128 toward each other to collapse the horizontal member 612 to raise the water pipe 608 or move the wheels apart to expand the horizontal member 628 to lower the water pipe 624).

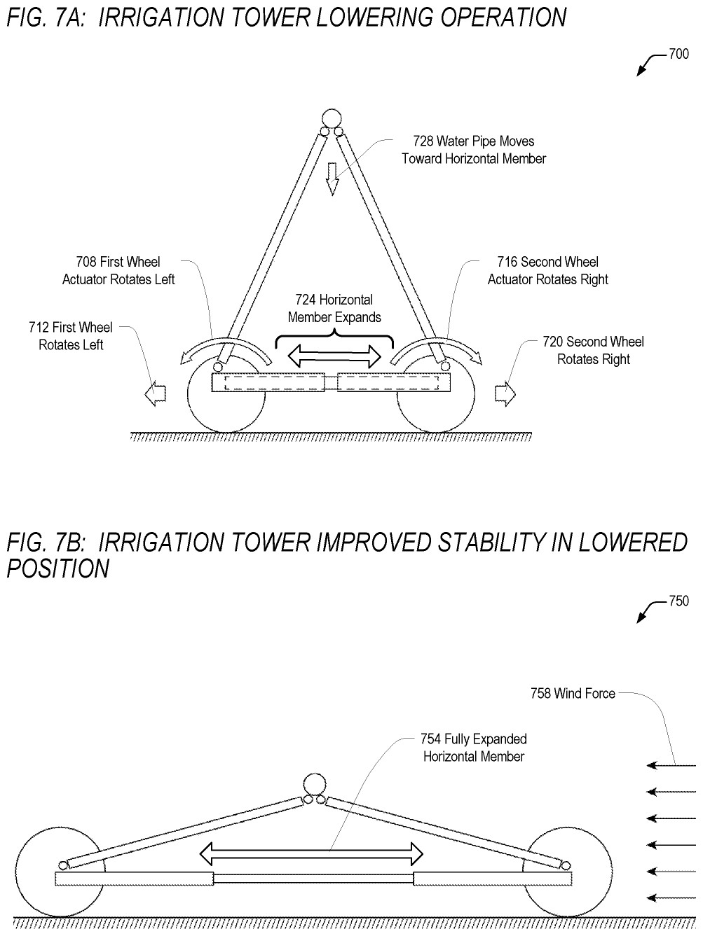

Referring now to FIG. 7A, a diagram illustrating a side view of an irrigation tower lowering operation 700 in accordance with embodiments of the present invention is shown. FIG. 7A illustrates an irrigation tower 316 of a first embodiment during a lowering process.

Assuming a pair of wheels 128 on the irrigation tower 316, the lowering process starts when the controller transmits a first command to a first drive unit 328 (of either wheel 128) to rotate to the outside or left in the illustration 708. In one embodiment, the command may enable a corresponding voltage to the first drive unit 328 that causes the corresponding wheel 128 to rotate to the left 712 (i.e., an opposite voltage applied to a drive unit 328, positive instead of negative or negative instead of positive, would cause the corresponding wheel 128 to rotate to the right). In another embodiment, the controller would transmit a signal as described herein, either through a wired connection to the first drive unit 328 or wirelessly to a wireless receiver and processor associated with the first drive unit 328.

The controller also transmits a second command to a second drive unit 328 (of a second wheel 128) to rotate to the outside or right in the illustration 716. In one embodiment, the command may enable a corresponding voltage to the second drive unit 328 that causes the corresponding wheel 128 to rotate to the right 720. In another embodiment, the controller would transmit a signal as described herein, either through a wired connection to the second drive unit 328 or wirelessly to a wireless receiver and processor associated with the second drive unit 328. As a result of the first wheel rotating to the left 712 and the second wheel rotating to the right 720, the horizontal member expands 724 and causes the water pipe to lower toward the horizontal member 728.

Referring now to FIG. 7B, a diagram illustrating a side view of irrigation tower improved stability in the lowered position 750 in accordance with embodiments of the present invention is shown. FIG. 7B illustrates the end result of the lowering process.

As the irrigation tower 316 continues to lower, the horizontal member becomes fully expanded 754. In one embodiment, the horizontal member may become fully expanded when one or more of the expanding members of the horizontal member reach a mechanical stop point. For example, a lateral projection in a sub-member of the horizontal member may come in contact with another projection or stop in another sub-member of the horizontal member and be unable to move/slide further. In another embodiment, the controller or actuator may enable the actuator for an amount of time to reach a fully expanded position 754. In yet another embodiment, a stop associated with the horizontal member may include a switch that closes when the horizontal member is fully expanded 754. The switch may provide a signal to the actuator that inhibits further movement or rotation by the actuator.

In the fully expanded position 754, the irrigation tower 316 has a significantly lower center of gravity than when the horizontal member is collapsed 612 and the water pipe is in the raised position 608. Additionally, in the first embodiment, the wheels 128 are spaced much further apart in the lowered position 624 than when in the raised position 608. Spacing the wheels 128 further apart reduces the tip-over danger even further. A lateral wind force 758 may exert the most tip-over force on the irrigation tower 316. Significant reduction of the center of gravity coupled with spacing the wheels 128 out further may eliminate the blow-over danger to all but the highest practical winds.

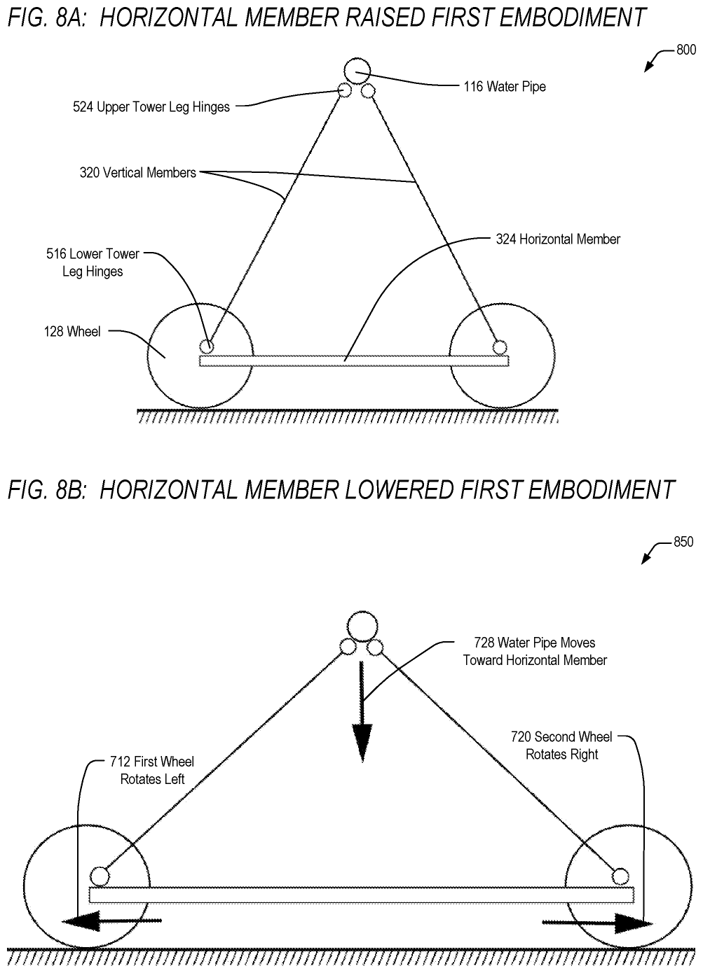

Referring now to FIG. 8A, a diagram illustrating a raised horizontal member 800 in accordance with a first embodiment of the present invention is shown. FIG. 8A illustrates various aspects previously illustrated and discussed with the respect to the first embodiment of the wind-resistant irrigation tower 316. In the first embodiment, the horizontal member 324 expands and collapses in order to lower and raise, respectively, the water pipe 116 with respect to the horizontal member 324.

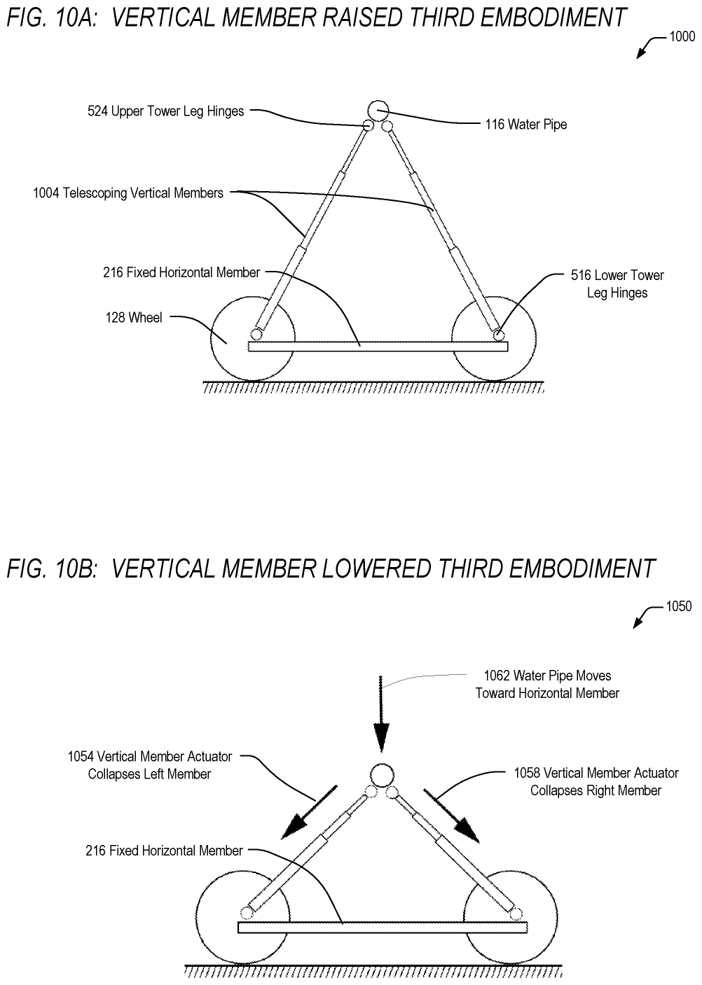

In one sub-embodiment, the horizontal member 324 may be configured as shown in FIG. 3B, with a central member sliding within two other end-members. In another sub-embodiment (not shown), the horizontal member 324 may be configured with two outside members sliding over a central member. In another sub-embodiment (not shown), the horizontal member 324 may be configured as a number of telescoping sections that collapse within each other, similar to the telescoping vertical members 1004 illustrated in FIGS. 10A and 10B.

The first embodiment may include upper tower leg hinges 524 coupled between the water pipe 116 and top ends of each of the vertical members 320. The first embodiment may also include lower tower leg hinges 516 coupled between bottom ends of each of the vertical members 320 and ends of the horizontal member 324. With respect to the top ends of the vertical members 320, in a sub-embodiment the upper tower leg hinges 524 may be replaced by a pair of independent sleeves over the water pipe 116 (not shown). One independent sleeve may be attached to a top end of one vertical member 320 and a second independent sleeve may be attached to a top end of a second vertical member 320. The sleeves must be independent from one another because the sleeves rotate in opposite directions during irrigation tower 316 raising or lowering operations.

Referring now to FIG. 8B is a diagram illustrating a lowered horizontal member 850 in accordance with a first embodiment of the present invention is shown. FIG. 8B illustrates a change in pivoting with respect to the vertical members 320 and the horizontal member 324 during a representative lowering operation. The first wheel rotates to the left 712, which reduces an angle at the lower tower leg hinge corresponding to the left wheel 128. The second wheel rotates to the right 720, which reduces an angle at the lower tower leg hinge corresponding to the right wheel 128. The wheel 128 rotations cause the wheels to move apart from each other and the water pipe moves toward the horizontal member 728.

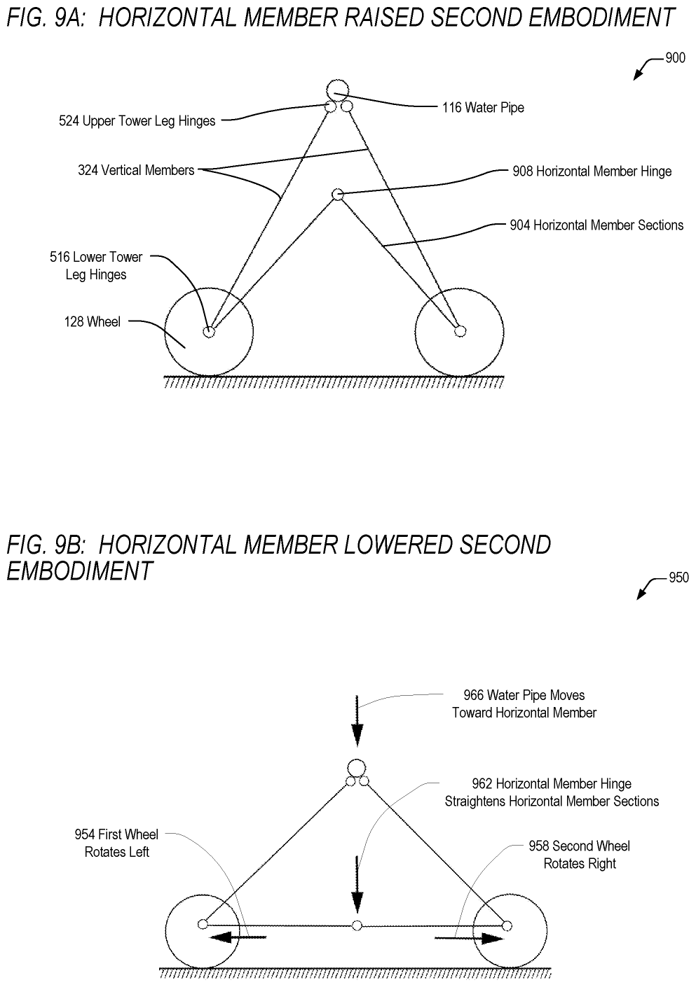

Referring now to FIG. 9A is a diagram illustrating a raised horizontal member 900 in accordance with a second embodiment of the present invention is shown. FIG. 9A illustrates a second embodiment where the horizontal member collapses in a different way from the first embodiment. Instead of a telescoping or collapsing in-line horizontal member 324 of the first embodiment, the horizontal member of the second embodiment includes two or more horizontal member sections 904, where each pair of adjacent horizontal member sections 904 are joined by a horizontal member hinge 908 that allows the horizontal member sections 904 to pivot and fold with respect to each other. The second embodiment may include the same vertical members 320, upper tower leg hinges 524, and lower tower leg hinges 516 as the first embodiment.

Referring now to FIG. 9B is a diagram illustrating a lowered horizontal member 950 in accordance with a second embodiment of the present invention is shown. FIG. 9B illustrates the movement operations involved in lowering the height of a wind-resistant irrigation tower 316 of the second embodiment.

The second embodiment may use the same drive unit 328 arrangement as the first embodiment, as well. However, the raising and lowering process is slightly different with respect to the horizontal member. The controller directs the first wheel to rotate to the left 954 and directs the second wheel to rotate to the right 958. This causes the horizontal member hinge (or all horizontal member hinges 908, if more than one) to straighten the horizontal member sections 962 and move the water pipe toward the horizontal member 966, thereby lowering the irrigation tower 316.

Referring now to FIG. 10A is a diagram illustrating a raised vertical member 1000 in accordance with a third embodiment of the present invention is shown. FIG. 10A illustrates key components of the third embodiment.

Unlike the variable horizontal member of the first and second embodiments, the third embodiment utilizes variable vertical members, specifically telescoping vertical members 1004, and a fixed horizontal member 216. Each of the telescoping vertical members 1004 includes a number of sections that collapse to a short second member length and expand to a longer second member length. The third embodiment may include the upper tower leg hinges 524 (or alternately, rotating sleeves around the water pipe 116, as discussed herein) and the lower tower leg hinges 516 of the first and second embodiments.

Referring now to FIG. 10B is a diagram illustrating a lowered vertical member in accordance with a third embodiment of the present invention is shown. FIG. 10B illustrates the movement operations involved in lowering the height of a wind-resistant irrigation tower 316 of the third embodiment.

The third embodiment includes independent vertical member actuators (not shown; may be internal to each telescoping vertical member 1004). The controller directs one vertical member actuator to collapse the left vertical member 1054 and directs another vertical member actuator to collapse the right vertical member 1058. As a result of the actuators collapsing the left and right vertical members 1004, the water pipe moves toward the horizontal member 1062. In one embodiment, the left and right vertical members 1004 collapse to a minimal length.

To raise the irrigation tower 316, the controller directs one vertical member actuator to expand the left vertical member and directs another vertical member actuator to expand the right vertical member. As a result of the actuators expanding the left and right vertical members 1004, the water pipe 116 moves away from the horizontal member to a raised position. In one embodiment, the left and right vertical members 1004 expand to a maximum length.

One disadvantage of the third embodiment compared to the first and second embodiments is that the distance between the wheels 128 does not change in the lowered position. However, a sub-embodiment of the third embodiment may include a variable-length horizontal member that collapses during lowering operations and expands during raising operations. This would move the wheels 128 further apart during lowering operations, thus increasing the stability of the wind-resistant irrigation tower 316 in high-wind environments.

In one embodiment, the controller may collapse the vertical members 1054, 1058 if a first wind speed threshold is exceeded (thus lowering the water pipe 116 and center of gravity). Then if the wind continues to increase and the controller determines a second wind speed threshold is exceeded, where the second threshold corresponds to a higher wind speed than the first threshold, the controller may direct the drive units 328 to rotate the wheels 128 apart. This may further lower the center of gravity and decrease the likelihood of being blown over in high winds.

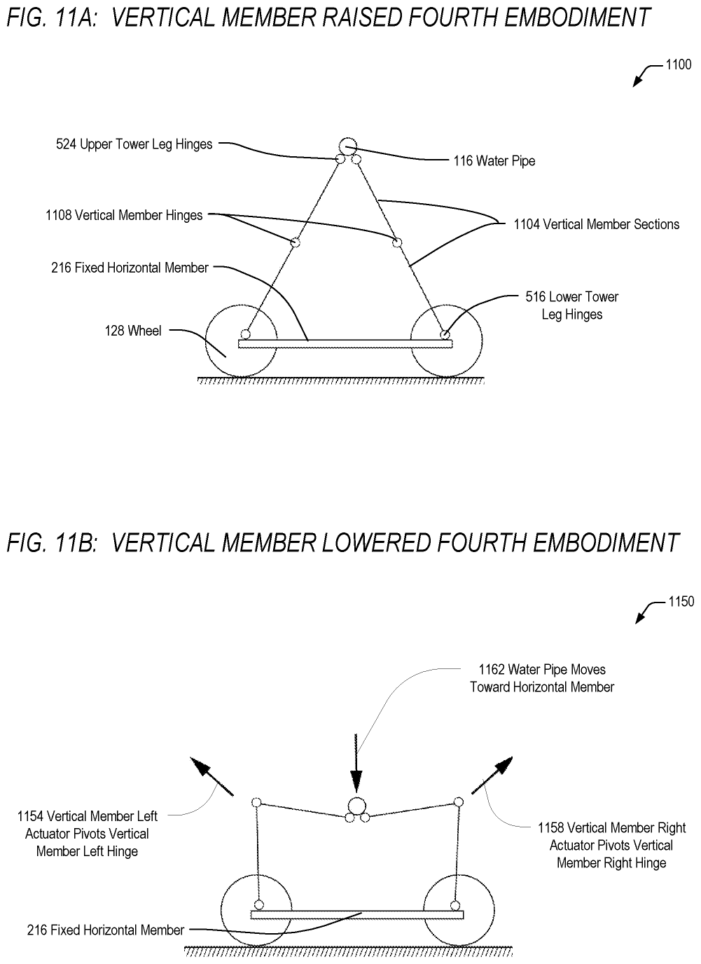

Referring now to FIG. 11A is a diagram illustrating a raised vertical member in accordance with a fourth embodiment of the present invention is shown. FIG. 11A illustrates key components of the fourth embodiment.

Unlike the variable horizontal member of the first and second embodiments, the fourth embodiment utilizes variable vertical members and a fixed horizontal member 216. Each vertical member may include two or more hinged vertical member sections 1104, where each pair of adjacent vertical member sections 1104 are joined by a vertical member hinge 1108 that allows the vertical member sections 1104 to pivot and fold with respect to each other.

An actuator (not shown) may be associated with each vertical member hinge 1108. In one embodiment, the actuator may pivot vertical member sections 1104 to the outside when directed to reduce the height of the water pipe 116 over the horizontal member 216. In another embodiment, the actuator may pivot vertical member sections 1104 to the inside when directed to reduce the height of the water pipe 116 over the horizontal member 216. The fourth embodiment may include the upper tower leg hinges 524 (or alternately, rotating sleeves around the water pipe 116, as discussed herein) and the lower tower leg hinges 516 of the first, second, and third embodiments.

Referring now to FIG. 11B is a diagram illustrating a lowered vertical member in accordance with a fourth embodiment of the present invention is shown. FIG. 11B illustrates the movement operations involved in lowering the height of a wind-resistant irrigation tower 316 of the third embodiment.

The fourth embodiment may use the same horizontal member and wheel 128 arrangement as the third embodiment, as well. However, the raising and lowering process is slightly different with respect to the vertical members.

The fourth embodiment includes independent vertical member actuators (not shown; may be in proximity to each vertical member hinge 1108). The controller directs left side vertical member actuator(s) to pivot the left vertical member 1154 and directs right side vertical member actuator(s) to pivot the right vertical member 1158. As a result of the actuators pivoting the left and right vertical member sections 1104, the water pipe moves toward the horizontal member 1162. In one embodiment, the left and right vertical members 1004 pivot to a minimal vertical member length.

To raise the irrigation tower 316, the controller directs left side vertical member actuator(s) to pivot the left vertical member sections 1104 to straighten the left side member sections 1104 and directs the right-side vertical member actuator(s) to pivot the right vertical member sections 1104 to straighten the right-side vertical member sections 1104. As a result of the actuators straightening the left and right vertical member sections 1104, the water pipe 116 moves away from the horizontal member to a raised position. In one embodiment, the left and right vertical members straighten to a maximum length.

One disadvantage of the fourth embodiment compared to the first and second embodiments is that the distance between the wheels 128 does not change in the lowered position. However, a sub-embodiment of the fourth embodiment may include a variable-length horizontal member that collapses during lowering operations and expands during raising operations. This would move the wheels 128 further apart during lowering operations, thus increasing the stability of the wind-resistant irrigation tower 316 in high-wind environments.

In one embodiment, the controller may pivot the vertical member sections 1154, 1158 if a first wind speed threshold is exceeded (thus lowering the water pipe 116 and center of gravity). Then if the wind continues to increase and the controller determines a second wind speed threshold is exceeded, where the second threshold corresponds to a higher wind speed than the first threshold, the controller may direct the drive units 328 to rotate the wheels 128 apart. This may further lower the center of gravity and decrease the likelihood of tipping over.

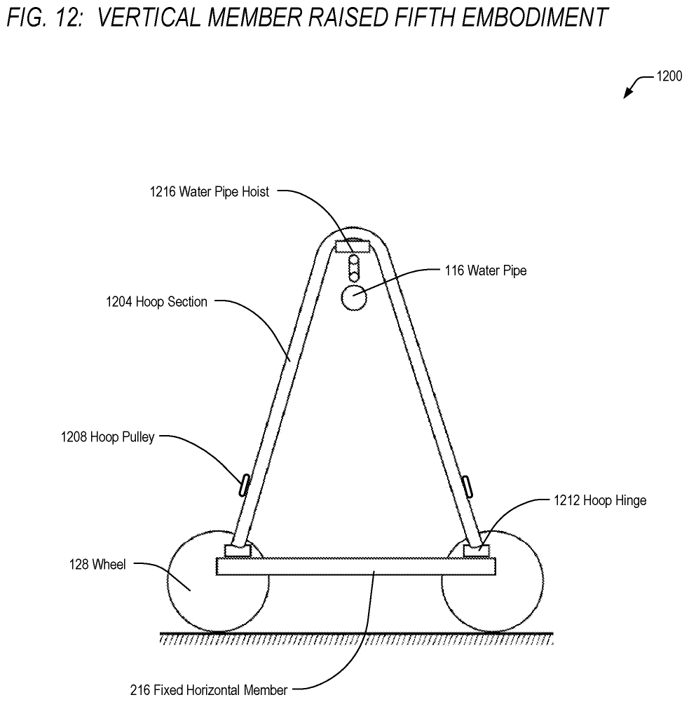

Referring now to FIG. 12 is a diagram illustrating a raised vertical member 1200 in accordance with a fifth embodiment of the present invention is shown. FIG. 12 illustrates key components of the fifth embodiment.

Unlike the variable horizontal member of the first and second embodiments and variable vertical members of the third and fourth embodiments, the fifth embodiment utilizes vertical hoop sections 1204 and a fixed horizontal member 216. Each irrigation tower 316 includes a pair of hoop sections 1204, where the water pipe 116 is suspended from a water pipe hoist 1216 attached to a bend at the top of the hoop sections 1204. Each end of the hoop sections 1204 are attached to the horizontal member 216 by a hoop hinge 1212. The hoop hinges 1212 are oriented sideways to allow each hoop section 1204 to pivot orthogonally with respect to the wheels 128 and the horizontal member 216. A hoop pulley 1208 is attached to each side of each hoop section 1204 to allow cables to raise or lower each hoop section 1204, and therefore the water pipe 116.

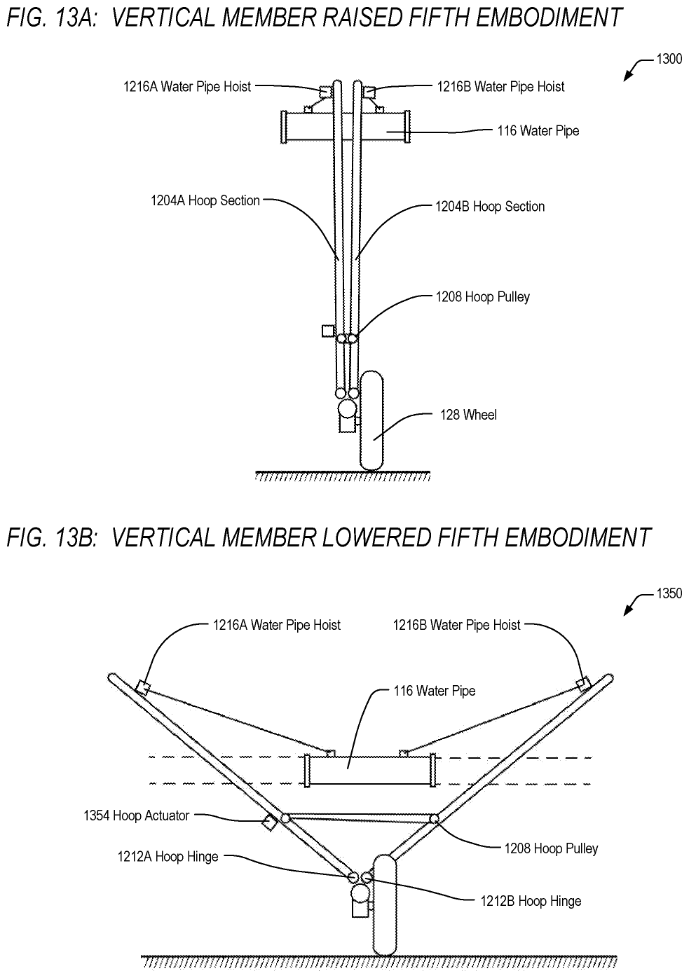

Referring now to FIG. 13A is a diagram illustrating a raised vertical member 1300 in accordance with a fifth embodiment of the present invention is shown. FIG. 13A illustrates a front view of an irrigation tower 316 of the fifth embodiment in a raised position.

FIG. 13A shows two hoop sections 1204, identified as hoop section 1204A and 1204B. Each hoop section 1204A, 1204B is coupled to the horizontal member 216 through a pair of transverse hinges 1212 that allows sideways pivoting of each of the hoop sections 1204A, 1204B. The water pipe 116 is suspended from a pair of water pipe hoists 1216, identified as water pipe hoist 1216A and 1216B. A hoop pulley 1208 is attached each side of one of the hoop sections 1204.

Referring now to FIG. 13B is a diagram illustrating a lowered vertical member 1350 in accordance with a fifth embodiment of the present invention is shown. FIG. 13B illustrates a front view of an irrigation tower 316 of the fifth embodiment in a lowered position.

The controller directs the fifth embodiment to get into a lowered position by directing hoop actuator 1354 to lengthen a cable between the hoop actuator and a hoop pulley 1208, and each of a pair of water pipe hoists 1216A, 1216B to lengthen a cable between the water pipe hoist 1216 and the water pipe 116. In one embodiment, the cable tensions between the hoop actuator 1354 cable and the water pipe hoist 1216 cables are substantially similar in order to minimize cable and attachment point stresses.

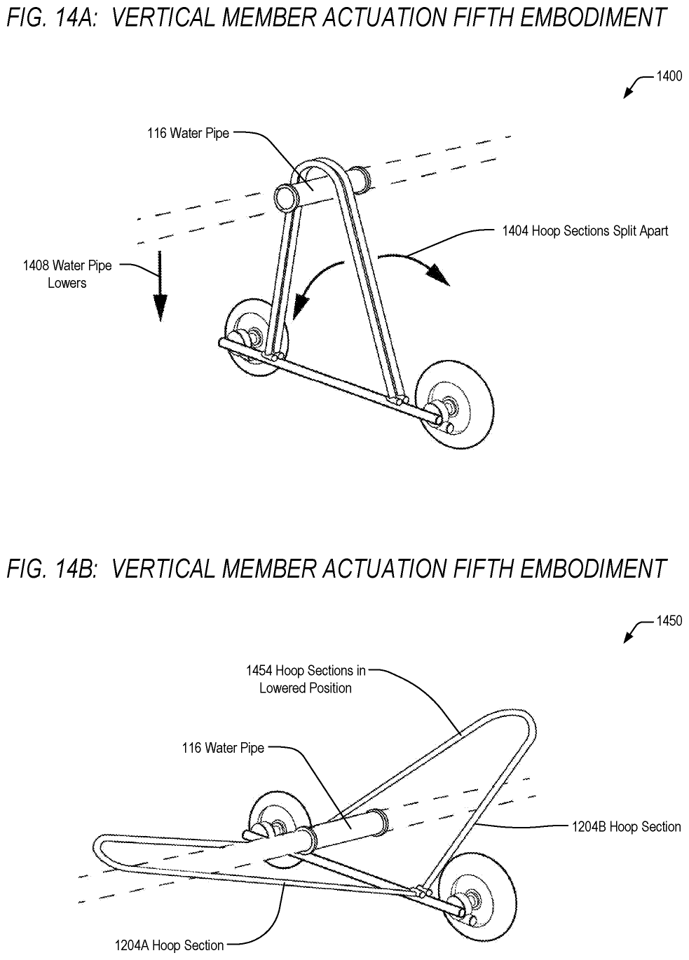

Referring now to FIG. 14A is a diagram illustrating vertical member actuation 1400 in accordance with a fifth embodiment of the present invention is shown. FIG. 14A illustrates an isometric view of vertical member actuation in a raised position of the fifth embodiment. Cables have been omitted from FIGS. 14A and 14B to provide improved clarity. From the raised position, the hoop sections split apart 1404, which lowers the water pipe 1408.

Referring now to FIG. 14B is a diagram illustrating vertical member actuation 1450 in accordance with a fifth embodiment of the present invention is shown. FIG. 14B illustrates an isometric view of vertical member actuation in a lowered position of the fifth embodiment. From the lowered position 1454, the hoop sections 1204A, 1204B are split apart 1404, which lowers the water pipe 116.

Referring now to FIG. 15, a flowchart illustrating an irrigation tower lowering process 1500 in accordance with embodiments of the present invention is shown. Flow begins at decision block 1504.

At decision block 1504, the controller determines if power is on to the system 100. Power is on to the system 100 means the controller, the actuators, the water pump 408, and any power distribution components between a power source and components that run on power are enabled to receive power from the power source. If the power is on, then flow proceeds to block 1512. If power is not on (i.e. power is off), then flow proceeds to block 1508.

At block 1508, main power to the system is reset. Resetting main power to the system may include resetting a circuit breaker, closing a switch, or any other manual action that allows power to flow from the power source to power-using components. Flow proceeds to block 1512.

At block 1512, the system 100 conducts normal irrigation operations. Normal irrigation operations is the normal operating mode of the system 100 in the absence of high wind events. The water pump 408 provides water at a designated water pressure through the water pipe 116 and suspended sprinklers 124, the controller issues commands or controls power voltages/waveforms to the actuators on the irrigation towers 316, and the irrigation arm 308 in a raised position rotates about the derrick 108 distributing water to the irrigated area 104. Flow proceeds to decision block 1516.

At decision block 1516, the controller determines if the current wind speed is greater than a warning threshold. The controller receives a current wind speed from a wind speed sensor 424 and continuously monitors the current wind speed. The warning threshold is a value stored in an accessible memory device that reflects potentially dangerous winds. In one embodiment, there may be a safety factor included in the warning threshold to allow time for the controller and actuators to move/rotate in order to proceed from the raised position to the lowered position. For example, if the system 100 requires one minute to deploy the irrigation towers 316 to the lowered position, the warning threshold may reflect a 30 MPh safety margin below a wind speed that may make the irrigation arm 300 unstable and potentially able to tip over. In one embodiment, the controller may determine the wind speed is greater than the warning threshold in response to a received weather forecast or high wind warning. If the current wind speed is greater than the warning threshold, then flow proceeds to block 1520. If the current wind speed is not greater than the warning threshold, then flow proceeds to block 1512 to continue normal irrigation operations.

At block 1520, the controller disables the water pump 408 and disables directional wheel 128 drive. Disabling the water pump 408 inhibits water flow through the water pipe 116. This will limit any water leaks from a damaged water pipe 116 to only the water currently in the water pipe 116. Disabling directional wheel drive prevents the wheels 128 from rotating in common directions. This prevents the irrigation arm 300 from rotating with respect to the irrigated area 104. In one embodiment, the controller may disable directional wheel drive 128 by inhibiting AC or DC power to the drive units 328. In another embodiment, the controller may disable directional wheel drive 128 by only allowing AC or DC power to the drive units 328 for commands that allow the drive units 328 to rotate the wheel of an irrigation tower 316 in opposite directions (i.e., to allow an expanding or collapsing horizontal member to move the wheels 128 together or apart). Flow proceeds to block 1524.

At block 1524, the controller activates horns and lowers the irrigation towers. The controller may control one or more horns in proximity to the system 100 to provide an audible warning while the irrigation towers 316 are transitioning from a raised position to a lowered position, as a safety measure. Lowering the irrigation towers 316 depends on activating actuators based on the embodiment or sub-embodiment used for the irrigation towers 316. Flow proceeds to block 1528.

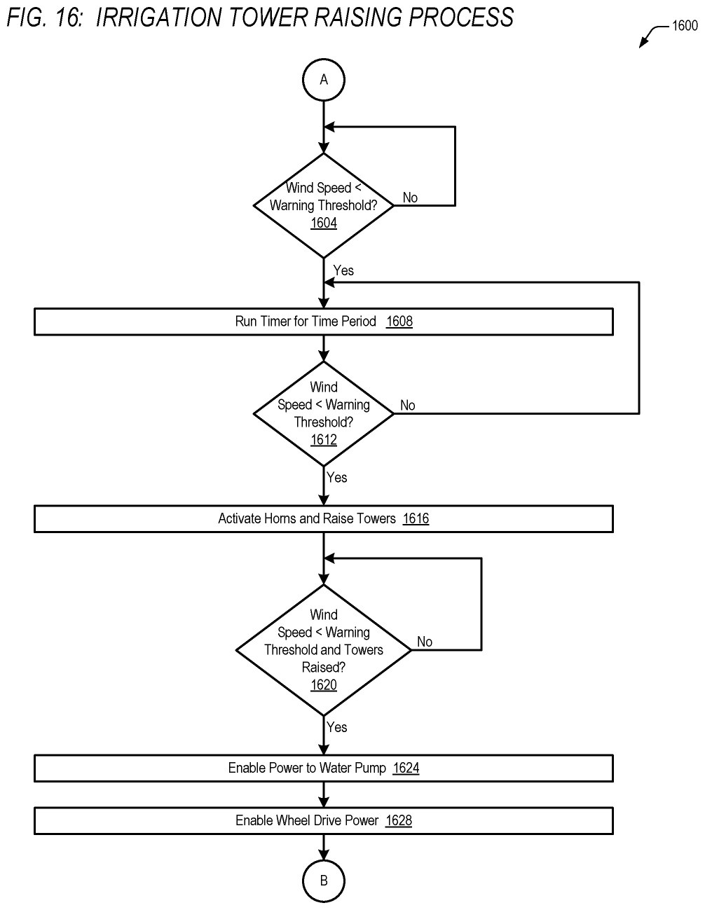

At block 1528, the controller inactivates the horns and the wheels are locked. In one embodiment, the horns remain activated until the irrigation tower 316 is in the lowered position. Once in the lowered position, the controller may inactivate the horns. In one embodiment, the controller may lock the wheels 128 of the irrigation towers 316 by inhibiting power to actuators. The actuators may be effectively locked in the absence of motive or rotational power. In another embodiment, the wheels 128 may have associated brakes, and the controller may send a command to the brakes to become engaged to hold the irrigation towers 316 in a static position. At this point, the system 100 has been secured for a high wind event. Flow proceeds to decision block 1604 of FIG. 16.

Referring now to FIG. 16, a flowchart illustrating an irrigation tower raising process 1600 in accordance with embodiments of the present invention is shown. Flow begins at decision block 1604.

At decision block 1604, the controller determines if the current wind speed is less than the warning threshold. The wind speed may vary and may drop below the warning threshold (e.g., an irrigated area 104 in an eye of a passing hurricane). If the wind speed remains above the warning threshold, then flow proceeds to decision block 1604 to continue monitoring the current wind speed. If the wind speed falls below the warning threshold, then flow proceeds to block 1608.

At block 1608, the controller runs a timer for a predetermined time period. The predetermined time period is to ensure the current wind speed is stable at a level below the warning threshold. For example, the predetermined time period may be 10 minutes. If the current wind speed does not stay below the warning threshold for the predetermined time period, the controller maintains the irrigation tower 316 in the lowered position. Flow proceeds to decision block 1612.

At decision block 1612, the controller determines if the current wind speed is (still) less than the warning threshold at the end of the predetermined time period. If the current wind speed is still below the warning threshold, then it may be safe to restore the irrigation towers 316 to the raised position and resume irrigation operations. In one embodiment, the controller may also require a weather report or wind advisory indicating high winds are no longer expected for the area of the system 100. If the current wind speed is (still) less than the warning threshold, then flow proceeds to block 1616. If the current wind speed is not less than the warning threshold, then flow proceeds to block 1608 to restart the timer and check again at the end of a next predetermined time period.

At block 1616, the controller activates horns and raises the irrigation towers. The controller may control one or more horns in proximity to the system 100 to provide an audible warning while the irrigation towers 316 are transitioning from a lowered position to a raised position, as a safety measure. Raising the irrigation towers 316 depends on activating actuators based on the embodiment or sub-embodiment used for the irrigation towers 316. Flow proceeds to decision block 1620.

At decision block 1620, the controller determines if the current wind speed is (still) less than the warning threshold and the towers are in the fully raised position. If the controller determines the current wind speed is less than the warning threshold and the towers are in the fully raised position, then flow proceeds to block 1624. If the controller determines either the current wind speed is not less than the warning threshold or the towers are not in the fully raised position, then flow proceeds to decision block 1620 to continue to check.

At block 1624, the controller enables power to the water pump. Enabling power to the water pump 408 resumes water flow through the water pipe 116. This will prepare the system 100 for resuming irrigation operations for the irrigated area 104. Flow proceeds to block 1628.

At block 1628, the controller enables wheel drive power. Enabling power restores directional wheel drive to the wheels 128 of the irrigation towers 316. At this point, the irrigation system 100 has fully been restored to operational status. Flow proceeds to block 1512 to resume normal irrigation operations.

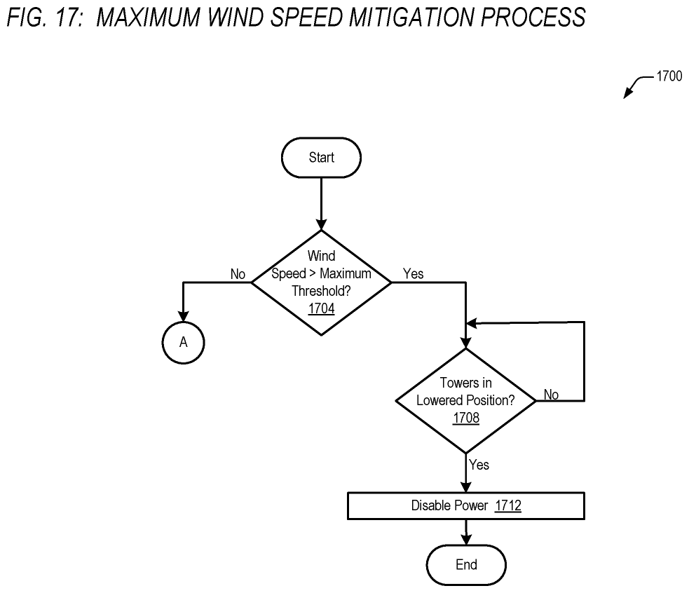

Referring now to FIG. 17, a flowchart illustrating a maximum wind speed mitigation process in accordance with embodiments of the present invention is shown. The maximum wind speed is constantly monitored by the controller during normal irrigation operations 1512, while the irrigation towers 316 are being lowered (FIG. 15), and while the irrigation towers 316 are being raised (FIG. 16). Flow begins at decision block 1704.

At decision block 1704, the controller determines if the current wind speed is greater than a maximum threshold. The maximum threshold is higher than the warning threshold, and may correspond to a current wind speed that may result in damage or destruction of the system 100 or system 100 components. The maximum threshold may be stored in an accessible storage device to the controller. If the controller determines the current wind speed is greater than the maximum wind speed, then flow proceeds to decision block 1708. If the controller determines the current wind speed is not greater than the maximum wind speed, then flow proceeds to decision block 1604 of FIG. 16 to check for the current wind speed being over the warning threshold.

At decision block 1708, the controller checks if the irrigation arm is in a lowered position 312. In one embodiment, it may be important to make sure the irrigation arm is in the lowered position 312 to prevent or minimize damage to the system 100. If the controller determines the irrigation arm is in the lowered position 312, then flow proceeds to block 1712. If the controller determines the irrigation arm is not in the lowered position 312, then flow proceeds to decision block 1708 to continue checking until the irrigation arm is in the lowered position 312 (i.e., the irrigation arm 316 may be in the process of transitioning between the raised position 308 and the lowered position 312).

At block 1712, the system 100 trips a main circuit breaker powering the entire irrigation system 100. This will require a visit from the owner/operator to confirm that the system 100 is intact and the weather is safe to resume operations, and only then will they reset the main circuit breaker providing power to the system 100. The system 100 will restart by restoring the irrigation towers 316 to normal operating positions 308, restoring the water pump 408 to operational status, and lastly restarting the rotation of the irrigation arm 300 about the irrigated area 104. Flow ends at block 1712. In one embodiment, the system 100 may transition directly from decision block 1704 to block 1712 and bypass decision block 1708.

Finally, those skilled in the art should appreciate that they can readily use the disclosed conception and specific embodiments as a basis for designing or modifying other structures for carrying out the same purposes of the present invention without departing from the spirit and scope of the invention as defined by the appended claims.

1. An irrigation tower, comprising:
a pair of vertical members, a first end of each coupled to a water pipe and configured to pivot in relation to the water pipe;
a horizontal member, each end coupled to a second end of each of the pair of vertical members and configured to pivot in relation to the second ends; and
a plurality of wheels, each coupled to the horizontal member,
wherein a distance between ends of one of the horizontal member or the pair of vertical members is configured to change to lower or raise the water pipe with respect to the horizontal member.

2. The irrigation tower of claim 1, further comprising:
a plurality of drive units, each coupled to one of the plurality of wheels and configured to independently rotate an associated wheel as directed by a controller, wherein the controller directs the drive units to one of:
rotate the plurality of wheels in a first direction of rotation to move the irrigation tower in a first direction; or
rotate the plurality of wheels in a second direction of rotation opposite the first direction of rotation to move the irrigation tower in a second direction opposite the first direction,
wherein the controller is further configured to enable or disable power to the plurality of drive units, wherein in response to the controller disables power to the plurality of drive units, movement of the irrigation tower in the first or second directions is inhibited.

3. The irrigation tower of claim 2, wherein each of the pair of vertical members comprises one of:
a plurality of telescoping vertical member sections, configured to collapse to a minimum vertical member length and expand to a maximum vertical member length; and
a vertical member actuator, coupled between the first and second ends of the vertical member, configured to expand or collapse the associated vertical member as directed by the controller,
wherein the water pipe is at a maximum height over the horizontal member in response to the vertical member is expanded to a maximum length,
wherein the water pipe is at a minimum height over the horizontal member in response to the vertical member is collapsed to a minimum length;
or
a plurality of vertical member sections joined in an end-to-end configuration;
one or more hinges, joining each pair of adjacent vertical member sections; and
one or more vertical member actuators, coupled between each pair of adjacent vertical member sections, configured to pivot vertical member sections with respect to the one or more hinges, as directed by the controller,
wherein the water pipe is at a minimum height over the horizontal member in response to the one or more hinges are pivoted to a sharpest angle, wherein the water pipe is at a maximum height over the horizontal member in response to the one or more hinges are not pivoted.

4. The irrigation tower of claim 3, wherein the controller is configured to receive a current wind speed from a wind speed sensor, wherein in response to the current wind speed exceeds a warning threshold, the controller is configured to inhibit a water flow through the water pipe, inhibit irrigation tower movement in the first or second directions, and direct the one or more vertical member actuators to lower the water pipe with respect to the horizontal member.

5. The irrigation tower of claim 4, wherein in response to the current wind speed falls below the warning threshold for a period of time after exceeding the threshold, the controller is configured to direct the one or more vertical member actuators to raise the water pipe with respect to the horizontal member, enable the water flow through the water pipe, and enable irrigation tower movement in the first or second directions.

6. The irrigation tower of claim 3, wherein the drive units and vertical member actuators are configured to receive power from a power source, wherein the controller inhibits power to the drive units and vertical member actuators in response to the irrigation tower is lowered and a current wind speed is at or above a maximum wind speed threshold.

7. The irrigation tower of claim 2, wherein the controller further directs the plurality of drive units to one of:
rotate two or more of the wheels apart to lower the water pipe, and in response increase a distance between the ends of the horizontal member; or
rotate two or more of the wheels toward one another to raise the water pipe and in response decrease a distance between the ends of the horizontal member.

8. The irrigation tower of claim 7, wherein the horizontal member comprises one of:
a pair of axle sleeves, wherein one end of each axle sleeve is coupled to the second end of one of the pair of vertical members; and
a beam axle; retained by and configured to slide within, the pair of axle sleeves;
or
a pair of axle sleeves, wherein one end of each axle sleeve is coupled to the second end of one of the pair of vertical members; and
a beam axle; retained by and configured to slide outside, the pair of axle sleeves.

9. The irrigation tower of claim 7, wherein the horizontal member comprises:
a plurality of telescoping horizontal member sections, configured to collapse to a minimum horizontal member length and expand to a maximum horizontal member length,
wherein the water pipe is at a maximum height over the horizontal member in response to the horizontal member is collapsed to a minimum length, wherein the water pipe is at a minimum height over the horizontal member in response to the horizontal member is expanded to a maximum length.

10. The irrigation tower of claim 7, wherein the horizontal member comprises:
a plurality of horizontal member sections joined in an end to end configuration; and
one or more hinges, joining each pair of adjacent horizontal member sections,
wherein the water pipe is at a maximum height in response to the one or more hinges are bent to a sharpest angle, wherein the water pipe is at a minimum height in response to one or more hinges are not bent.

11. The irrigation tower of claim 7, wherein the controller is configured to receive a current wind speed from a wind speed sensor, wherein in response to the current wind speed exceeds a warning threshold, the controller is configured to inhibit a water flow through the water pipe, inhibit irrigation tower movement in the first or second directions, and direct the plurality of drive units to lower the water pipe with respect to the horizontal member.

12. The irrigation tower of claim 11, wherein in response to the current wind speed falls below the warning threshold for a period of time after exceeding the threshold, the controller is configured to direct the plurality of drive units to raise the water pipe with respect to the horizontal member, enable the water flow through the water pipe, and enable irrigation tower movement in the first or second directions.

13. The irrigation tower of claim 11, wherein the plurality of drive units are configured to receive power from a power source, wherein the controller inhibits power to the drive units in response to the irrigation tower is lowered and a current wind speed is at or above a maximum wind speed threshold.

14. An irrigation system, comprising:
a fixed derrick, comprising:
a water source; and
a water pump, coupled to the water source;
an irrigation arm, comprising:
a water pipe, coupled to the water pump and extending radially away from the fixed derrick;
one or more sprinkler heads, coupled to the water pipe;
one or more irrigation towers, coupled to and transversely supporting the water pipe, each comprising:
a pair of vertical members, a first end of each coupled to the water pipe and configured to pivot in relation to the water pipe;
a horizontal member, each end coupled to a second end of each of the pair of vertical members and configured to pivot in relation to the second ends;
a plurality of wheels, each coupled to the horizontal member; and
a plurality of actuators, configured to raise or lower an associated irrigation tower;
a wind speed sensor, configured to provide a current wind speed; and
a controller; coupled to the wind speed sensor, configured to:
monitor the current wind speed;
determine the current wind speed is above a first threshold, and in response:
lower the one or more irrigation towers; and
determine the current wind speed is below a second threshold that is below the first threshold, and in response:
raise the one or more irrigation towers.

15. The system of claim 14, wherein the plurality of actuators comprises drive units coupled to each of the plurality of wheels, wherein the drive units are independently configured by the controller to one of rotate in a first rotation direction or rotate in a second rotation direction opposite the first rotation direction, wherein the controller is further configured to enable or disable power to the drive units, wherein in response to the controller disables power to the drive units, movement of the irrigation tower in the first or second directions is inhibited.

16. The system of claim 15, wherein each vertical member of the pair of vertical members comprises one of:
a plurality of telescoping vertical member sections, configured to collapse to a minimum vertical member length and expand to a maximum vertical member length; and
a vertical member actuator of the plurality of actuators, coupled between the first and second ends of the vertical member, configured to expand or collapse the vertical member as directed by the controller;
or
a plurality of vertical member sections joined in an end to end configuration;
one or more hinges, joining each pair of adjacent vertical member sections; and
one or more vertical member actuators of the plurality of actuators, coupled between each pair of adjacent vertical member sections, configured to pivot vertical member sections with respect to the one or more hinges, as directed by the controller.

17. The system of claim 16, wherein in response to the current wind speed exceeds a warning threshold, the controller is configured to inhibit the water pump, inhibit irrigation tower movement in the first or second directions, and direct the one or more vertical member actuators to lower the water pipe with respect to the horizontal member.

18. The system of claim 17, wherein in response to the current wind speed falls below the warning threshold for a period of time after exceeding the threshold, the controller is configured to direct the one or more vertical member actuators to raise the water pipe with respect to the horizontal member, enable the water pump, and enable movement of the one or more irrigation towers in the first or second directions.

19. The system of claim 16, wherein the vertical member actuators are configured to receive power from a power source, wherein the controller inhibits power to the vertical member actuators in response to the irrigation tower is lowered and a current wind speed is at or above a maximum wind speed threshold.

20. The system of claim 15, wherein the horizontal member is configured to expand or compress in length between ends of the horizontal member, wherein the horizontal member comprises one of:
a pair of axle sleeves, wherein one end of each axle sleeve is coupled to the second end of a different vertical member; and
a beam axle; retained by and configured to slide within, the pair of axle sleeves;
or
a pair of axle sleeves, wherein one end of each axle sleeve is coupled to the second end of a different vertical member; and
a beam axle; retained by and configured to slide outside, the pair of axle sleeves;
or
a plurality of telescoping horizontal member sections, wherein each end of the plurality of telescoping horizontal member sections is coupled to the second end of a different vertical member;
or
a plurality of horizontal member sections joined in an end to end configuration; and
one or more hinges, joining each pair of adjacent horizontal member sections, wherein each end of the plurality of horizontal member sections is coupled to the second end of a different vertical member.

21. The system of claim 20, wherein the controller lowers the one or more irrigation towers comprises the controller directs the drive units to rotate the plurality of wheels away from each other, wherein the controller raises the one or more irrigation towers comprises the controller directs the drive units to rotate the plurality of wheels toward each other.

22. The system of claim 21, wherein in response to the current wind speed exceeds a warning threshold, the controller is configured to inhibit the water pump, inhibit irrigation tower movement in the first or second directions, and direct the drive units to lower the water pipe with respect to the horizontal member.

23. The system of claim 22, wherein in response to the current wind speed falls below the warning threshold for a period of time after exceeding the threshold, the controller is configured to direct the drive units to raise the water pipe with respect to the horizontal member, enable the water pump, and enable irrigation tower movement in the first or second directions.

24. The system of claim 21, wherein the drive units are configured to receive power from a power source, wherein the controller inhibits power to the drive units in response to the irrigation tower is lowered and a current wind speed is at or above a maximum wind speed threshold.
